(19) United States
(12) Patent Application Publication
(10) Pub. No.: US 2010/0052223 A1
(43) Pub. Date: Mar. 4, 2010

(54) CNT/METAL COMPOSITE CABLE

(75) Inventors: Yong Hyup KIM, Seoul (KR); Wal Jun KIM, Seoul (KR)

Correspondence Address: KNOBBE MARTENS OLSON & BEAR LLP, 2040 MAIN STREET, FOURTEENTH FLOOR, IRVINE, CA, 92614, US

(73) Assignee: SEOUL NATIONAL UNIVERSITY RESEARCH & DEVELOPMENT BUSINESS FOUNDATION (SNU R&DB FOUNDATION), Seoul (KR)

(21) Appl. No.: 12/198,840

(22) Filed: Aug. 26, 2008

(51) Int. Cl. B06B 1/02

(52) U.S. Cl. 264/442; 264/479; 977/742

(57) ABSTRACT

Methods for producing a carbon nanotube (CNT)/metal composite cable including preparing a CNT/metal solution, dipping a metal tip into the dispersed CNT/metal solution, and withdrawing the metal tip from the dispersed CNT/metal solution while applying an electric field between the metal tip and the dispersed CNT/metal solution, and related devices and apparatus are provided.

### TECHNICAL FIELD

The present disclosure relates generally to carbon nanotube (CNT)/metal composites and, more particularly, to CNT/metal composite cables.

### BACKGROUND

CNTs may be one-dimensional nano-materials having a high aspect ratio, high mechanical strength and excellent conductivity. Such unique properties allow them to be potentially useful in various fields such as nanotechnology, electronics, optics, etc.

### SUMMARY

Techniques for manufacturing a CNT/metal composite cable are provided. In one embodiment, a method for producing the CNT/metal composite cable may include preparing a dispersed CNT/metal solution, dipping a metal tip into the dispersed CNT/metal solution, and withdrawing the metal tip from the dispersed CNT/metal solution while applying an electric field between the metal tip and the dispersed CNT/metal solution. Optionally, the dispersed CNT/metal solution may be continuously provided to obtain a desired length of the CNT/metal composite cable. Various devices using the above CNT/metal composite cable are also disclosed herein. The CNT/metal composite cable may improve electric and mechanical properties since metal ions provide ionic bonding between CNTs.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a flowchart of an illustrative embodiment of a method for manufacturing a CNT/metal composite cable.

FIG. 2 is a schematic diagram of an illustrative embodiment of a device for constructing a CNT/metal composite cable.

FIG. 3 is a schematic diagram of an illustrative embodiment of a device for constructing a W-tip.

FIG. 4 is a picture obtained using a scanning electron microscope (SEM) showing a CNT/metal composite cable according to an illustrative embodiment.

FIG. 5 is an enlarged view of the squared portion in FIG. 4 showing an end portion of a CNT/metal composite cable according to an illustrative embodiment.

### DETAILED DESCRIPTION

In the following detailed description, reference is made to the accompanying drawings, which form a part hereof In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the components of the present disclosure, as generally described herein, and illustrated in the Figures, may be arranged, substituted, combined, and designed in a wide variety of different configurations, all of which are explicitly contemplated and made part of this disclosure.

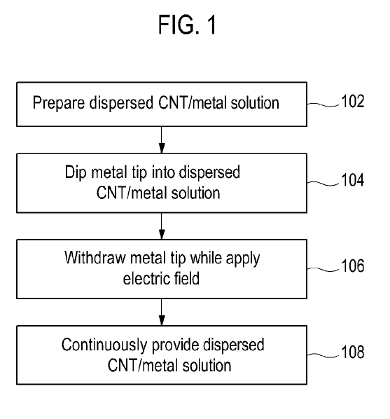

A novel technology is provided to produce a carbon nanotube (CNT)/metal composite cable for diverse applications. FIG. 1 is a flowchart of an illustrative embodiment of a method for providing a CNT/metal composite cable. As depicted, a dispersed CNT/metal solution may be prepared at operation 102. A metal tip may be dipped into the dispersed CNT/metal solution at operation 104. The metal tip may be withdrawn from the dispersed CNTs/metal solution while an electric field may be applied at operation 106. Optionally, the dispersed CNT/metal solution may be continuously provided to obtain a desired length of the CNT/metal composite cable at operation 108. Each of the operations 102, 104, 106, 108 will be further discussed below.

### Preparing the Dispersed CNT/Metal Solution: Operation 102

At operation 102, the dispersed CNT/metal solution may be prepared to provide CNTs and metal ions. In one embodiment, single-walled carbon nanotubes (SWNTs), which may provide good electric field emission properties, may be used. In other embodiments, multi-walled carbon nanotubes (MWNTs) may be used. In some embodiments, Cu may be used as the metal ion. In other embodiments, a variety of metals that may be plated, such as, but not limited to, Ni, Au, Ag, or metal oxides, such as, but not limited to, WO₄ and TiO₂ may be used. In one embodiment, copper sulfate, such as, but not limited to, Cu₂SO₄.5H₂O and a surfactant, such as, but not limited to, SDS (sodiumdodecylsulfate) may be dissolved in a solvent, such as, but not limited to, DMF (N,N-dimethylformamide) to produce Cu ions. In other examples, DCE (1,2-dichloroethane), chloroform, hexane, etc. may be used as the solvent. In other examples, cTAB (cetyltrimethylammonium bromide) may be used as the surfactant. The SWNTs may be added and they may be treated with sonication to produce a well-dispersed CNT/Cu solution. Therefore, a dispersed CNTs/metal solution containing SWNTs and Cu ions may be provided.

Dipping a Metal Tip into the Dispersed CNT/Metal Solution: Operation 104

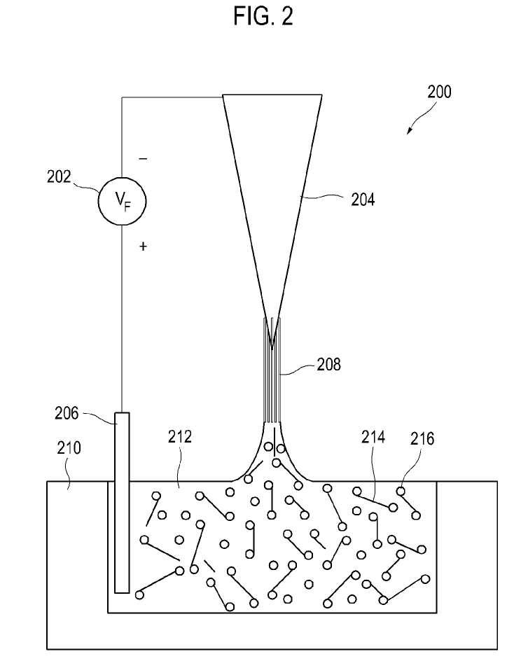

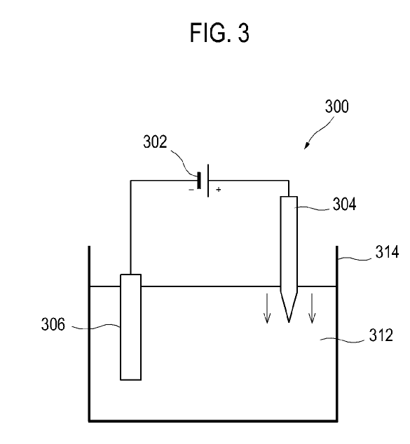

FIG. 2 is a schematic diagram of an illustrative embodiment of a device for constructing a CNT/metal composite cable. As depicted, a producing device 200 may include a power supply 202, a tungsten (W)-tip 204, to which power may be applied and to which a CNT/Cu composite cable 208 may be attached, a platinum (Pt) electrode 206 which may be a counter electrode of the W-tip 204, and a bath 210 which may contain a dispersed CNT/Cu solution 212 prepared, for example, as described in operation 102. The dispersed CNT/Cu solution may include CNTs 214 and Cu ions 216. At operation 104 (please refer also to FIG. 1), the W-tip 204 may be dipped into the dispersed CNT/Cu solution 212 in a bath 210. In an example, the bath 210 may be made of or include a hydrophobic material, such as, but not limited to poly(tetrafluoroethylene) (Teflon®). The W-tip 204 may be prepared using an electrochemical etching method, which is explained below with reference to FIG. 3.

FIG. 3 is a schematic diagram of an illustrative embodiment of a device for constructing a W-tip. The producing device for the W-tip 204 may include a power supply 302, a W-wire 304, a Pt electrode 306, and a solution 312 in a bath 314. In one example, the power supply may be a DC power supply. The W-wire may include a variety of suitable diameters such as, but not limited to a diameter of about 0.3 mm, and the diameter of the W-wire may range from about 0.1 mm to about 5 mm, from about 0.2 mm to about 4 mm, from about 0.3 mm to about 3 mm, or from about 0.5 mm to about 2 mm, and accordingly, the claimed subject matter is not limited in this respect. In an example, solution 312 may be a 1.5M KOH (or NaOH) solution.

The W-wire 304 may be dipped into the solution 312 near or adjacent to the Pt electrode 306. Then, a voltage, such as, for example, 25V DC from the power supply 302 may be applied between the W-wire 304 and the Pt electrode 306 for approximately 8 to 10 seconds, which may result in the following anodic oxidation reaction.

(−): 6H₂O+6e⁻→3H₂(g)+6OH⁻

(+): W(s)+8OH⁻→WO₄²⁻+4H₂O+6e⁻

The W-wire 304 may be etched as the anodic oxidation reaction may proceed. In this embodiment, a W-tip (which may have, for example, an approximately 250 nm in apex curvature) may be produced by electrochemically etching the 0.3 mm-diameter W-wire 304. Although W is discussed, a variety of suitable metals may be used such as, for example, indium may be used in the tip to produce the CNT/Cu composite cable 208, and accordingly, the claimed subject matter is not limited in these respects. An etched W-tip may be useful for producing the CNT/metal composite cable, as the etched W-tip may facilitate contact between the etched W-tip and the CNTs.

Producing the CNT/Cu composite cable 208 using the dispersed solution and the W-tip is explained below with reference to operation 106.

Withdrawing the W-Tip while Applying an Electric Field: Operation 106

After dipping the W-tip 204 into the CNT/Cu solution 212 in the bath 210 at operation 104, the W-tip 204 may be withdrawn from the CNT/metal solution 212 at a variety of suitable rates such as, for example, about 0.1 mm/min. to about 1.5 mm/min at operation 106 (please refer to FIG. 1), and accordingly, the claimed subject matter is not limited in this respect. In some embodiments, the withdrawal rate of the W-tip 204 may range from about 0.1 mm/min. to about 2.0 mm/min., from about 0.25 mm/min. to about 2.0 mm/min., from about 0.5 mm/min. to about 2.0 mm/min., from about 0.75 mm/min. to about 2.0 mm/min., from about 1.0 mm/min. to about 2.0 mm/min., from about 1.25 mm/min. to about 2.0 mm/min., from about 1.5 mm/min. to about 2.0 mm/min., from about 1.75 mm/min. to about 2.0 mm/min., from about 0.1 mm/min. to about 1.5 mm/min., from about 0.1 mm/min. to about 1.25 mm/min., from about 0.1 mm/min. to about 1.0 mm/min., from about 0.1 mm/min. to about 0.75 mm/min., from about 0.1 mm/min. to about 0.5 mm/min., or from about 0.1 mm/min. to about 0.25 mm/min. In other embodiments, the raising speed of the metal tip 112 may be a constant value of, e.g., about 0.1, 0.2, 0.3, 0.5, 0.7, 0.9, 1.0, 1.25, 1.5, 1.75, or 2 mm/min. An electric field from the power supply 202 may be applied simultaneous to the withdrawal, between the W-tip 204 (negative) and the CNT/Cu solution 212 (positive). In one embodiment, DC power may be used for the power supply 202.

### Continuously Providing the Dispersed CNT/Metal Solution: Operation 108

At optional operation 108, the dispersed CNT/Cu solution 212, which may be stored in a separate tank (not shown), may be continuously provided to the bath 210 for a pre-determined time such that the desired length of the CNT/Cu composite cable 208 may be obtained. By providing additional dispersed CNT/metal solution 212 to the bath 210 (for example, by providing it continuously or as it is about to be exhausted), any length of CNT/Cu composite cable 208 may be produced. As a desired length of the CNT/Cu composite cable 208 is obtained at operation 108, it may be rapidly withdrawn from the bath 210 in order to stop its growth.

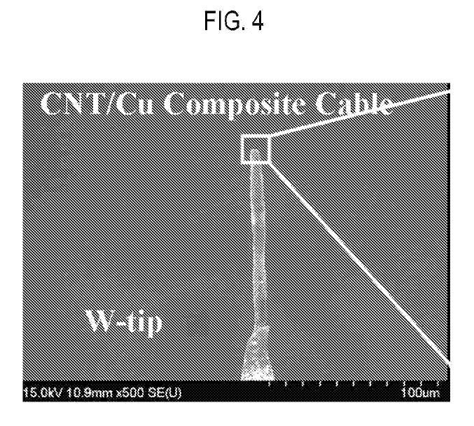

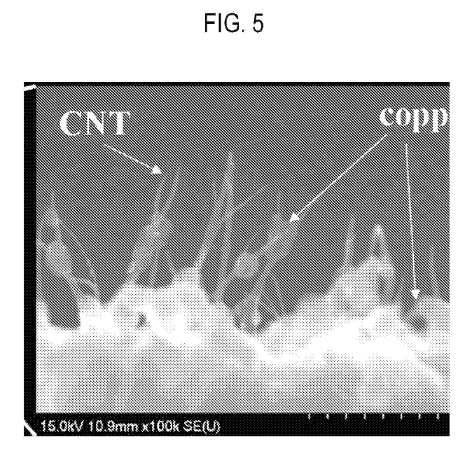

The CNT/metal composite cable may be obtained as illustrated in FIGS. 4 and 5. FIG. 4 is a picture obtained using a scanning electron microscope (SEM) showing the CNT/metal composite cable according to an illustrative embodiment, and FIG. 5 is an enlarged view of the squared portion in FIG. 4. As depicted in FIG. 4, a long CNT/Cu composite cable, which may be produced as described, may be attached to a W-tip. FIG. 5 depicts the end portion of the CNT/Cu composite cable, which may include the CNTs and with Cu ions.

Hereinafter, the properties and applications of the embodiments are explained. Electric and mechanical properties of the CNT/metal composite cable may be managed by controlling various parameters, such as, for example, the volume fraction between CNTs and Cu. In general, the electric and mechanical properties of a CNT may be superior to those of Cu. However, in a cable formed only of CNTs, each of CNTs in the cable may adhere to neighboring CNTs by relatively weak van der Waals forces and may create relatively high contact resistance between the CNTs, and a cable of CNTs may be easily broken when a mechanical force may be applied. In the above embodiment of the CNTs/Cu composite cable, however, Cu may improve the contact resistance and adhesion of the CNTs. That is, the CNT/Cu composite cable may improve electric and mechanical properties since metal ions may provide ionic bonding between CNTs.

Generally, a geometric structure with a high aspect ratio may have good electric field emission properties. In this regard, the CNT/metal composite cable may efficiently emit substantially high electric fields and may achieve substantially high current densities. The CNT/metal composite cable may be grounded and a voltage may be applied to an anode spaced from the CNT/metal composite cable, and electrons may be emitted from the end of the CNT/metal composite cable by a tunneling effect. Thus, the CNT/metal composite cable may be used as an electric field emission emitter.

The CNT/metal composite cable may have substantial mechanical strength due to adhesion between CNTs and the metal, and the CNT/metal composite cable may be applied to various applications including, but not limited to, space elevators, tether satellites, or the like. Further, the CNT/metal composite cable may be used as a high current cold cathode for electron sources in various applications. Therefore, the CNT/metal composite cable may be applied to an X-ray generator, a SEM electron source, a tunneling electron microscope (TEM) electron source, a THz imaging electron source, or a gas ionizer. Further, since the CNT/metal composite cable may have good mechanical/electric properties, the CNT/metal composite cable may be applied to an Electrical Discharge Machining (EDM) tool, a coaxial cable, or an electric wire.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A method for producing a carbon nanotube (CNT)/metal composite cable comprising:
providing a CNT/metal solution;
disposing a metal tip in the CNT/metal solution;
withdrawing the metal tip from the CNT/metal solution while applying an electric field between the metal tip and the CNT/metal solution.

2. The method of claim 1, further comprising:
continuously providing the CNT/metal solution for a predetermined time to obtain a desired length of the CNT/metal composite cable.

3. The method of claim 1, wherein said providing the CNT/metal solution comprises:
providing a solution to produce metal ions;
adding carbon nanotubes (CNTs) to the solution; and
performing a sonication treatment to the solution.

4. The method of claim 3, wherein the metal ions comprise at least one of Cu, Ni, Au, Ag, WO₄, or TiO₂.

5. The method of claim 3, wherein said providing the solution to produce the metal ions comprises:
dissolving a copper sulfate and a surfactant in a solvent.

6. The method of claim 5, wherein the copper sulfate comprises Cu₂SO₄.5H₂O.

7. The method of claim 5, wherein the surfactant comprises at least one of sodiumdodecylsulfate or cetyltrimethylammonium bromide.

8. The method of claim 5, wherein the solvent comprises at least one of N,N-dimethylformamide, 1,2-dichloreothane, chloroform, or hexane.

9. The method of claim 1, wherein the CNT/metal solution comprises single walled carbon nanotubes (CNTs).

10. The method of claim 1, wherein the metal tip is prepared using an electrochemical etch.

11. The method of claim 1, wherein the metal tip comprises at least one of W or In.

12. The method of claim 1, wherein the metal tip comprises W, and wherein said withdrawing the metal tip from the CNT/metal solution includes withdrawing the metal tip at a rate of about 0.1 mm/min to 1.5 mm/min.

13. The method of claim 1, wherein the CNT/metal solution is contained in a bath including a hydrophobic material.

14. The method of claim 13, wherein the hydrophobic material comprises poly(tetrafluoroethylene) (Teflon®)

15. The method of claim 3, wherein the metal ions comprise Cu and wherein the volume fraction between the CNTs and Cu is controlled to produce the CNT/Cu composite cable.

16. The method of claim 1, wherein said applying the electric field between the metal tip and the CNT/Cu solution comprises applying the electric field using a DC power supply.
